(19) United States
(12) Patent Application Publication
(10) Pub. No.: US 2025/0086940 A1
(43) Pub. Date: Mar. 13, 2025

(54) METHOD AND SYSTEM FOR AUTOMATICALLY ANNOTATING SENSOR DATA

(71) Applicant: dSPACE GmbH, Paderborn (DE)

(72) Inventors: Simon ROMANSKI, Karlsruhe (DE); Daniel ROEDLER, Karslruhe (DE); Fabian BOTH, Karlsruhe (DE); Andreas WONISCH, Muenchen (DE)

(73) Assignee: dSPACE GmbH, Paderborn (DE)

(21) Appl. No.: 18/882,540

(22) Filed: Sep. 11, 2024

(30) Foreign Application Priority Data
Sep. 11, 2023 (EP) 23196456.0

(51) Int. Cl. G06V 10/764; G01S 17/86; G06T 11/20; G06V 10/82

(52) U.S. Cl. CPC G06V 10/765; G01S 17/86; G06T 11/20; G06V 10/82; G06T 2210/12

(57) ABSTRACT

A computer-implemented method is provided for automatically annotating sensor data frames of a spatial sensor and of an area sensor with a spatially overlapping measuring range. Received sensor data frames are initially independently annotated, a bounding box being assigned to each recognized object in the sensor data frame. The sensor data frames of the spatial sensor and the sensor data frames of the area sensor are grouped, based on a temporal correlation. The three-dimensional bounding box for an object is projected into the image plane of the area sensor. If a measure of quality for a match between the projected bounding box and the two-dimensional bounding box is above a predefined threshold value, the boxes are assigned to the same object, and this object is not further checked. Attributes of the object may be subsequently determined.

This nonprovisional application claims priority under 35 U.S.C. § 119(a) to European Patent Application No. 23196456.0, which was filed on Sep. 11, 2023, and which is herein incorporated by reference.

### BACKGROUND OF THE INVENTION

### Field of the Invention

The present invention relates to methods and computer systems for automatically annotating sensor data frames, in particular data frames of image recording sensors.

### Description of the Background Art

Advances in autonomous driving require large quantities of sufficiently different training data and validation data (i.e., independent ground truth data). The processing of training data generally starts with recording a large number of different driving scenarios by a vehicle that is equipped with a set of sensors, in particular image recording sensors, such as one or more cameras, a lidar sensor, and/or a radar sensor. These recorded scenarios must be annotated before they are used as training data. The exact annotations required (for example, the object classes to be distinguished) depend on each project and are indicated in the detailed labeling specification. Larger annotation projects, which for example would deliver enough ground truth data for validating an autonomous vehicle, require automation of the annotation process.

Automation approaches use neural networks for labeling the recorded sensor data. An initial set of the received data is manually labeled and then used to train neural networks. As soon as they are sufficiently trained, the neural networks can annotate the volume of data recorded by the image recording sensor. Compared to a strictly manual approach, this reduces the complexity considerably. However, maintaining a high level of annotation quality still requires time-consuming quality checks by humans.

A method and a system for automatically annotating sensor data frames by use of a neural network are known from WO 2023/135244 A1, which is incorporated herein by reference. Data points, for example coordinates of bounding boxes or properties of recognized objects, are assigned to the sensor data frames. State attributes that describe environmental conditions, for example, during the recording of the sensor data frame are assigned to the data points. Based on the state attributes, the data points are grouped to take into account correlations between state attributes and the accuracy of the annotations. A first sample of one or more data points is selected from a first group, and a measure of quality for the data points in the first sample is determined. If the measure of quality of the first sample is below a predefined threshold value, a manual correction must take place. After corrected annotations for the data points in the first sample are received, the neural network is retrained based on the data points in the first sample. A check of further samples, manual correction, and retraining of the neural network may be repeated until the measure of quality of a sample exceeds the predefined threshold value. The method allows identification of state attributes that have an adverse effect on the annotation quality, and improvement of the neural network under these conditions by selective retraining. A high level of annotation quality with a reduced number of manual quality checks may be ensured in this way.

In the recognition of objects, two types of errors may occur: false positives (FPs), i.e., the presumed recognition of an object although no object is actually present, and false negatives (FNs), i.e., the failure to recognize an object that is actually present. A manual correction of false negatives is clearly more complicated than that of false positives, since the insertion of a missing bounding box also requires entry of geometric parameters such as the coordinates of the corner points, whereas in the case of FPs the incorrect bounding box need only be deleted. However, in the case of FNs it is also necessary to reperform the automatic annotation using neural networks, since various annotations build on one another, and for example a determination of object attributes requires the presence or the prior recognition of an object. Therefore, even in the case of a certain increase in the false positives, a reduction in false negatives would result overall in less complexity for the annotation.

Thus, there is still a need for improved methods for automatically annotating sensor data, in particular image recording sensor data, and it would be particularly desirable to achieve a high sensitivity level or a high recall level.

### SUMMARY OF THE INVENTION

It is therefore an object of the present invention to provide methods and computer systems for automatically annotating sensor data frames, in particular video frames or lidar point clouds.

In a first aspect of the invention, a computer-implemented method for automatically annotating sensor data frames is provided; the method comprises the steps of receiving a plurality of sensor data frames, including sensor data frames of a spatial sensor, in particular a lidar sensor, and sensor data frames of an area sensor, in particular a camera, wherein the measuring ranges of the spatial sensor and of the area sensor spatially overlap; annotating the plurality of sensor data frames using at least one neural network, wherein the annotation includes recognizing objects and assigning a bounding box to each object; grouping a sensor data frame of the spatial sensor and a sensor data frame of the area sensor based on a temporal correlation of the measuring points in time; projecting at least four corners of a three-dimensional bounding box of a recognized object, i.e., a bounding box in the sensor data frame of the spatial sensor, into the image plane of the area sensor to obtain a projected rectangle; and checking whether the relative overlap, i.e., the intersection over union, between the projected rectangle and a neighboring two-dimensional bounding box, i.e., a bounding box in the sensor data frame of the area sensor, exceeds a threshold value, in particular a threshold value of at least 0.50. If the relative overlap exceeds the threshold value, the three-dimensional bounding box and the neighboring two-dimensional bounding box are linked to the same object, and attribute recognition is carried out for the object. If the relative overlap does not exceed the threshold value, a correction of the bounding boxes takes place.

The computer system, which carries out the method according to the invention, may be implemented as an individual host computer that includes a processor, for example an all-purpose microprocessor, a monitor, and an input device. Alternatively, the computer system may include one or more servers that include a plurality of processing elements such as processor cores or dedicated accelerators, the servers being connected via a network to a client that has a monitor and an input device. In this way, the annotation or the automation software, which includes components for the automatic annotation, may be executed partially or completely on a remote server, for example in a cloud computing environment, so that only a graphical user interface has to be locally implemented.

A spatial sensor can be understood to mean an image recording sensor that supplies spatial information or three-dimensional information, so that the measured data of the spatial sensor include 3D coordinates; in particular this may be a lidar sensor or a radar sensor. An area sensor can be understood to mean an image recording sensor that supplies two-dimensional information, so that the measured data of the area sensor have only two dimensions; in particular this may be a camera.

A temporal correlation of the measuring points in time means that the sensor data frames have been recorded within a predefined short time interval. Due to this approximate simultaneity of the measured data of the spatial sensor and the area sensor, objects in the overlap area of the measuring ranges must be visible on both sensors. For lidar sensor data frames or lidar point clouds, an average value of the measuring times of the individual points of the lidar point cloud may be used as a measuring point in time of the sensor data frame. Alternatively, the recording point in time of a camera image may be compared to the start time and the end time of the lidar sensor data frame, in particular a simultaneous recording or a temporal correlation of the sensor data frames being assumed when the recording point in time of the camera image is between the start time and the end time of the lidar point cloud.

The lidar sensor data frame may advantageously be preprocessed to compensate for a distortion of the point cloud caused by the longer recording time. The camera and the lidar sensor are preferably calibrated to one another, which may take place based on a previous recording of a checkerboard pattern, so that there is only a small amount of residual uncertainty.

The relative overlap may be determined by the ratio of the intersection of two bounding boxes to the union of the two bounding boxes; this measure is also known as intersection over union (IoU).

The present invention is based on the consideration that bounding boxes that are present on two mutually independent sensor data frames and that have a sufficient relative overlap may be used without manual quality checking. Due to the fact that the bounding boxes are present in two different sensor modalities, in particular a lidar measurement and a camera image, the likelihood of an error is extremely low. The corresponding objects in the point cloud and the camera image may therefore be automatically linked to the same object; this may take place, for example, by assigning the same object identification number. As a result of using the temporal correlation as a plausibility check, the presence of an object may be verified in an automated manner. On the one hand it is not necessary to invest further effort in verifying the object, and on the other hand, subsequent evaluation steps for determining object attributes are applied only to verified objects, so that time and energy are saved.

Prior to grouping a sensor data frame of the spatial sensor and a sensor data frame of the area sensor, based on a temporal correlation of the measuring points in time, tracking of objects in sequential sensor data frames of the spatial sensor and/or tracking of objects in sequential sensor data frames of the area sensor preferably take(s) place. The tracking, i.e., the following of an object, makes use of relationships between successive recordings of the same object, and advantageously also takes into account physical laws, in particular kinematic equations, for plausibility checking of objects. The temporal context is taken into account, for example how an object must initially move in the vicinity of the edge before it may permanently disappear. During the tracking, the data of a sensor are considered, in each case independently of data of another sensor.

The projection of at least four corners of a bounding box in the sensor data frame of the spatial sensor into the image plane of the area sensor preferably includes selection of a rectangle, in particular the largest rectangle obtained from the projection, and a regression of the size advantageously takes place for the projected rectangle and/or the bounding box of the area sensor. The regression of the size may advantageously take place using a neural network that is trained to determine the optimal size of a bounding box. In particular in the case of a poor calibration of the relative orientation between the spatial sensor and the area sensor, the regression of the size may ensure greatly improved recognition, since otherwise, for example an angular shift of ±2 degrees for a remote object would result in it being incorrectly recognized as two separate objects. A regression of the size may take place before or after the relative overlap is determined. In an example, a check is initially made for occlusion, in particular using a neural network that is trained for occlusion detection; after the three-dimensional bounding box and the two-dimensional bounding box have been linked, a regression of the size for the bounding box of the object subsequently takes place, it being possible for the projected bounding box or the bounding box of the area sensor to be selected as the bounding box of the object. Alternatively, in principle a regression of the size may take place before the relative overlap is checked.

The correction of the bounding boxes can include receiving corrected annotations for the sensor data frames of the sample and retraining the neural network, using the sensor data frames of the sample. By retraining the neural network when an insufficient overlap has been recognized as an indication of false negatives, the quality of the automatic plausibility check may be continuously improved.

The correction of the bounding boxes when a bounding box is present in the sensor data frame of the spatial sensor preferably can include receiving a determination of whether an incorrect object recognition was present, and if an object was actually present, projection of the corners of the three-dimensional bounding box of the object into the image plane of the area sensor takes place in order to obtain a projected rectangle, and a regression of the size of the projected rectangle is subsequently carried out. The regression of the size may advantageously take place using a neural network that is trained to determine the optimal size of a bounding box. After the three-dimensional bounding box that is present has been verified in a manual check as recognition of a genuine object, so that a false positive may be ruled out, the 3D box is advantageously automatically projected into the image plane, and by automatic regression of the size a two-dimensional bounding box of appropriate size and position is created and linked to the same object. The two-dimensional bounding box is linked to the same object as the three-dimensional bounding box.

The correction of the bounding boxes when a bounding box is present in the sensor data frame of the area sensor preferably includes receiving a determination of whether an incorrect object recognition was present, and if an object was actually present, projection of measuring points of the point cloud of the spatial sensor into the image plane of the area sensor takes place, and the measuring points whose projection is situated within the two-dimensional bounding box are highlighted in the point cloud. The measuring points in the point cloud of the spatial sensor, whose projection lies within the two-dimensional bounding box of the area sensor, with a high likelihood belong to the incorrectly overlooked object. This highlighting reduces the effort for checking the point cloud. The highlighting may take place via a color change in a graphical illustration for a human quality checker, and/or via a change in intensity and/or weighting of the measuring points in question for an automatic evaluation using a neural network. The three-dimensional bounding box resulting from the manual correction or automatic evaluation is advantageously linked to the same object as the two-dimensional bounding box.

The plurality of sensor data frames can also include, in addition to sensor data frames of a spatial sensor, in particular of a lidar sensor, sensor data frames of at least two area sensors, in particular cameras, the measuring ranges of the spatial sensor and of the first area sensor spatially overlapping in a first overlap area, and the measuring ranges of the spatial sensor and of the second area sensor spatially overlapping in a second overlap area; for objects in the first overlap area an automatic annotation takes place according to the method according to the invention, independently of sensor data frames of the second area sensor, and for objects in the second overlap area an automatic annotation takes place according to the method according to the invention, independently of sensor data frames of the first area sensor. The measuring range of the spatial sensor generally includes the measuring ranges of the various area sensors, so that a reference is advantageously established between the measuring ranges of two area sensors, in particular two cameras, via the sensor data frame of the spatial sensor, in particular the lidar sensor. Overlap areas between various area sensors and the spatial sensor may thus be evaluated independently of one another.

Carrying out the attribute recognition for the object preferably includes assigning at least one object attribute to the object and assigning at least one state parameter to the object attribute. Furthermore, the method also comprises the steps of grouping the object attributes based on the at least one state parameter, wherein a first group object includes attributes for which the at least one state parameter lies in a defined value range; and selecting a sample of one or more object attributes from the first group and determining a measure of quality for the object attributes in the sample. If the measure of quality of the sample is below a predefined threshold value, the method further comprises the steps of receiving corrected annotations for the data points in the sample, and retraining the neural network based on the data points in the first sample.

It is advantageous when clustering or grouping of the object attributes or data points takes place, according to methods known per se, after the attribute recognition in order to identify state parameters or state attributes that have an adverse effect on the annotation quality. The consideration of the correlation according to the invention allows the presence of objects to be efficiently recognized, wherein the size of the bounding boxes does not yet have to be optimal. As the result of jointly grouping or clustering, in a subsequent step, the box coordinates for two-dimensional bounding boxes and three-dimensional bounding boxes assigned to the same object, influencing factors on the optimal box sizes may also be identified. Since other object attributes are often determined from the data of an individual sensor, in particular an area sensor, the conditions or state parameters that are relevant for this sensor are crucial for the quality of the attribute recognition. These may be recognized based on the sample, and the neural network may be retrained for recognizing the particular object attribute. If the annotation quality is capable of further improvement, checking of further samples, manual correction, and retraining of the neural network may be repeated until the measure of quality of a sample exceeds the predefined threshold value. For state attributes that have an adverse effect on the annotation quality, the neural network may be improved by selective retraining for the particular object attribute under unfavorable conditions. The annotation quality is improved in a targeted manner and with little complexity.

After successful sampling, the sensor data frames may be exported. The exporting of the annotated frames may encompass, for example, storing the frames on an external data medium and/or converting or combining into a predefined data format. Due to the fine granularity of the data points, in principle it would also be possible to deliver partially annotated sensor data frames. For the sake of better clarity, it may be advantageous to deliver sensor data frames to customers only after an adequately retrained neural network is available for all occurring types of data points, and the sensor data frames may thus be completely annotated.

For example, a relative overlap between an automatically created bounding box and a bounding box that is created or modified manually within the scope of the quality control may be used as a measure of quality. In addition, a maximum number and/or a maximum proportion of incorrectly assigned object attributes may be required, and/or a maximum deviation for numerical object attributes may be predefined. The measure of quality would then be below the predefined threshold value, for example when an excessively large number of object attributes lies outside predefined value ranges. Combined conditions may also be used in determining the measure of quality, for example by weighted combination of individual values.

The sensor data frames of the spatial sensor and the area sensor are image data frames, and thus include data of an imaging sensor, such as one or more cameras, a lidar sensor, and/or a radar sensor. The received sensor data may also include additional sensor data that have been recorded concurrently with the image data frames, such as a GPS position, an acceleration of the vehicle, or data from a rain sensor. The state parameters may be a geographical location, a time of day, a weather condition, a visibility condition, a roadway type, a distance from an object, and/or a traffic density, a size of a bounding box, an extent of an occlusion and/or clipping, or also an ego vehicle speed, a camera parameter, a color range, and/or a measure of contrast of an area encompassed by a bounding box, a travel direction of the ego vehicle, and/or astronomical information such as the position of the sun relative to the travel direction of the ego vehicle. The object attribute may be, for example, a class of an object or an activation of a light indicator such as a blinker light or a brake light.

The grouping of the object attributes preferably includes a determination of clusters in a multidimensional space, in particular using a nearest neighbor algorithm and/or an unsupervised learning approach and/or a machine learning classification model. Object attributes of a type can be assigned by the machine learning classification model to exactly one of at least two clusters having different expected quality levels. The assignment to a cluster may take place by classification or grouping in a multidimensional space that is spanned by a number of state parameters. Based on the combined static and dynamic state parameters, the individual object attributes may thus be assigned to various clusters. However, it may also be provided to utilize all or a predefined quantity of state parameters as context of the object attributes in order to determine which state parameters have a noticeable influence on the quality of the object attributes of this type.

An aspect of the invention further relates to a nonvolatile computer-readable medium containing instructions which, when executed by a microprocessor of a computer system, prompt the computer system to carry out the method according to the invention as described above or in the appended claims.

In a further aspect of the invention, a computer system is provided which includes a host computer having a processor, a working memory, a display, a device for human input, and a nonvolatile memory, in particular a hard disk or a solid-state disk. The nonvolatile memory contains instructions which, when executed by the processor, prompt the computer system to carry out the method according to the invention.

The processor may be a universal microprocessor that is typically used as the central unit of a personal computer, or may include one or a plurality of processing elements that is/are designed to perform particular computations, such as a graphics processor. In examples of the invention, the processor may be replaced or supplemented by a programmable logic device, such as an FPGA, that is configured to provide a defined scope of functions, and/or may include an IP core microprocessor.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an example of a computer system;

FIG. 2 shows an example of a sensor data frame, with a schematic diagram of possible data points in the insertion at the top left;

FIG. 3 shows a schematic diagram of an automation system that carries out a method according to the invention;

FIG. 4 shows a schematic diagram of a vehicle with overlapping measuring ranges of two sensors;

FIG. 5a shows an example of a camera image with a projected 3D bounding box; and

FIG. 5b shows an example of a camera image with a 2D bounding box.

### DETAILED DESCRIPTION

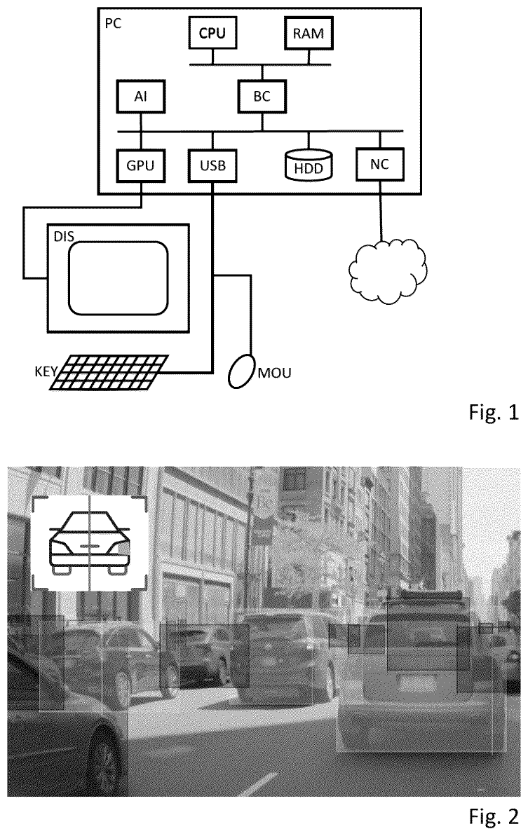

FIG. 1 illustrates an example of a computer system.

The shown example includes a host computer PC with a display DIS and user interface devices such as a keyboard KEY and a mouse MOU; in addition, an external server may be connected via a network, as indicated by a cloud symbol.

The host computer PC includes at least one processor CPU with one or more cores, a working memory RAM, and a number of devices that are connected to a local bus (such as PCI Express) which exchanges data with the CPU via a bus controller BC. The devices include, for example, a graphics processor GPU for controlling the display, a controller USB for connecting peripheral devices, a nonvolatile memory HDD such as a hard disk or a solid-state disk, and a network interface NC. In addition, the host computer may include a dedicated accelerator AI for neural networks. The accelerator AI may be designed as a programmable logic module such as an FPGA, as a graphics processor that is suitable for general computations, or as an application-specific integrated circuit. The nonvolatile memory preferably contains instructions which, when executed by one or more cores of the processor CPU, prompt the computer system to carry out a method according to the invention.

In examples, indicated in the figure as a cloud, the computer system may include one or more servers that have one or more processing elements, the servers being connected via a network to a client such as the host computer PC. The annotation environment may thus be partially or completely implemented on a remote server, for example in a cloud computer device. Mobile terminals may also be used as a client as an alternative to a host computer; thus, a graphical user interface of the annotation environment may be implemented in particular on a smart phone or a tablet with a touchscreen user interface.

FIG. 2 shows a camera image as an example of a sensor data frame, with a schematic diagram of possible data points in the insertion at the top left.

The photo of an urban setting shown in the figure can be an individual image of an area sensor or part of a video recording. In general, a recording provided by a customer may include sensor data frames that represent a sequential context, for example a five-minute trip that is recorded via imaging sensors such as a camera and a lidar sensor. Video recordings could be made up of a series of sequential frames, for example, which in turn contain a series of objects. The recording is processed using at least one neural network in order to create annotations. Annotations may include a plurality of data points, wherein each data point describes a specific aspect.

A data point is a parameter that describes a certain property of a recording, and may be applied to all detail levels. Detail levels may be the entire recording, a series of sequential or random frames, an individual frame, or an object on a frame. One specific example would be an annotation for an automobile, made up of a bounding box that describes the position of the automobile within a certain accuracy, a vertical line that marks an edge of the automobile, a classification for describing the type of automobile, attributes for clipping or occlusion, blinker lights, brake lights, color, and so forth. Within the scope of the present invention, it is advantageous to distinguish between bounding boxes as primary data points, which describe the presence (but also the coordinates) of an object, and secondary points, which as object attributes describe properties of an existing object more precisely. In principle, secondary data points may describe the class of an object, the activation of a blinker light and/or brake light, colors, subclasses, tracking information, degree of occlusion, degree of clipping (truncation), and complex classes that describe the relevance of an object/frame/clip, as well as sound, text, or any other information that can be automatedly determined. Only when an object is present, i.e., at least one primary data point is present, can a meaningful annotation with secondary data points take place.

Various data points for an automobile in the sensor data frame of an area sensor are illustrated in the insertion at the top left in the figure. Automobiles may be of various types, for example a delivery vehicle, an SUV, or a sports car. The position, or rather, the dimensions, of an automobile is/are generally indicated by a bounding box, i.e., a rectangular frame or a cuboid that encloses the automobile. Vertical lines indicate the boundaries of the automobile or allow a better indication of the position of the automobile. A further possible data point for an automobile is the activation of an indicator light, such as the travel direction indicator or blinker light shown in the insertion.

Numerous automobiles are present in the frame, each being enclosed by a bounding box. Automobiles may be completely visible, such as the vehicle traveling directly in front of the camera, or may be occluded. The traffic density in the urban setting may adversely affect the annotation quality, for example by making an accurate determination of the boundaries of the bounding box difficult because of occlusion.

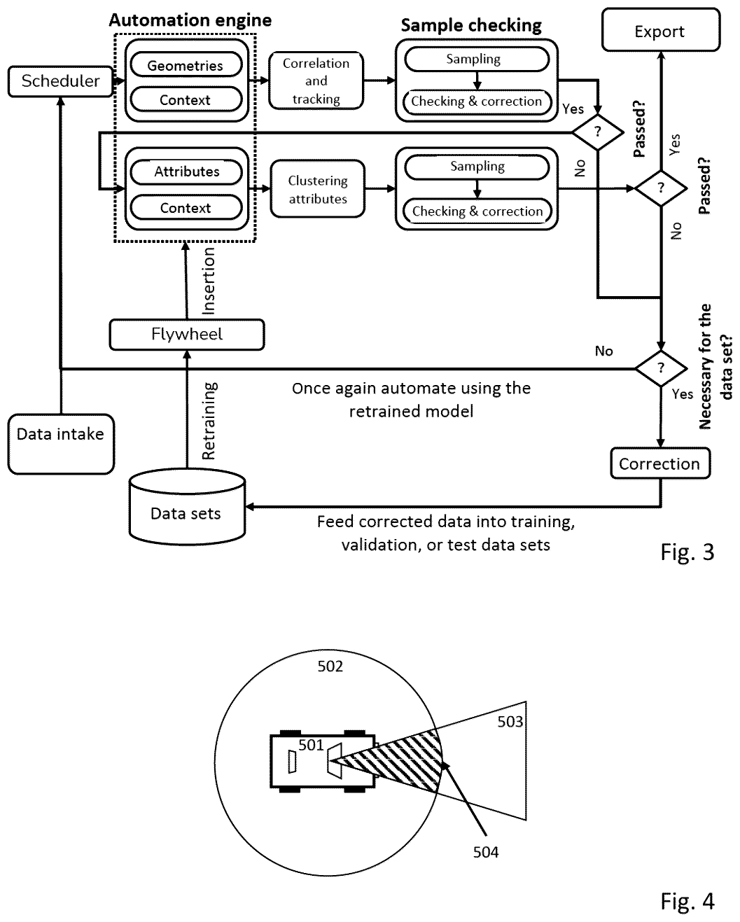

FIG. 3 shows a schematic diagram of an automation system that carries out a method according to the invention. The automation system implements various steps of the method in dedicated components, and is well suited for the execution in a cloud computing environment.

In a first component, “data intake,” unsorted recordings are received from a customer. The recordings may be normalized, for example divided into sensor data frames or images, to allow uniform processing. This component may also include an enrichment phase in which the sensor data frames of the recordings are automatically enriched with metadata that are relevant for measuring the automation quality. Thus, for example, the geographical location at which each image was recorded may be assigned to the image, in particular based on the GPS coordinates that were received concurrently with the images. In the context of autonomous driving, metadata or state parameters that are relevant for the quality of the annotation may include a weather condition, a roadway type, a light condition, and/or a time of day.

For the efficiency of the automation, it is meaningful to jointly process charges of frames or individual images in the subsequent steps or components. For projects with nested recording and processing of images, it may be advantageous to accumulate frames, recorded under the same environmental conditions, until a predefined charge size is reached before proceeding with the further processing steps.

In a second component, the “scheduler,” various charges of sensor data frames or individual images for the annotation are scheduled by an automation engine. The scheduler may select one or more automation components for annotating the frames with one or more data points for implementation by the automation engine. In addition, the scheduler may select, based on the availability of recent versions of automation components, the charge of frames to be processed. An automation component may generate an individual data point such as a vertical line, or multiple contiguous data points such as the coordinates of a bounding box and an object class. The automation components may be neural networks or some other technology based on machine learning that learn(s) from data samples in a supervised, semisupervised, or unsupervised manner.

In a third component, the “automation engine,” a charge of sensor data frames is processed by at least one automation component that assigns annotations to the frames. The automation system may implement various automation components in order to create different annotations or data points. The data points are preferably provided with metadata that describe the version of the automation component used; the automation system may store the data points and assigned metadata in one or more databases. Some of the state attributes associated with a data point may be determined by a dedicated automation component. The “context,” i.e., the state attributes for a data point, may include attributes which themselves are a data point. Thus, for example, the accuracy of placing a vertical line may be function of the size of the bounding box in which the line is to be drawn.

According to the invention, initially at least one automation component is implemented for the object detection and generates the bounding boxes around recognized objects, thus determining “geometries” of the objects. Sensor data frames of a spatial sensor as well as sensor data frames of an area sensor are evaluated.

A component for “correlation and tracking” is subsequently implemented, wherein initially tracking of objects between sequential frames of the spatial sensor, and tracking of objects between sequential frames of the area sensor, advantageously take place. During tracking or following of objects, a temporal context is taken into account for plausibility checking of bounding boxes. Objects must move in accordance with kinematic laws and cannot simply disappear, for example without having reached the edge of the measuring range of the sensor (or being occluded by a closer object, which is then visible in the sensor data frame). According to the invention, the spatial context of two overlapping sensor ranges is also taken into account for the plausibility checking. For example, when the camera sees an object, the lidar sensor must also measure an object, or vice versa. By utilizing the correlation between two sensors in overlapping measuring ranges, the sensitivity or the recall, i.e., the correct recognition of the presence of an object, may be increased.

FIG. 4 shows a schematic diagram of a vehicle with overlapping measuring ranges of two sensors. In the diagram illustrated in a bird's-eye view, a vehicle 501 that is oriented to the right and that has a spatial sensor, such as a lidar sensor, and an area sensor, such as a camera, is apparent. The measuring range 502 of the spatial sensor encompasses the entire surroundings of the vehicle; i.e., an angle of 360 degrees is swept over, wherein the range of a lidar sensor is limited by the maximum allowable emitted pulse energy and the sensitivity of the sensor to the backscattered light. The measuring range 503 of the area sensor is a cone directed to the right, wherein the maximum distance at which an object is recognizable may be a function of the light conditions prevailing at the time. The method according to the invention is applicable to objects in the overlap area 504 of the spatial sensor and the area sensor. This overlap area covers the travel direction of the vehicle, and is thus the most important region for driving functions. Recent vehicles often have further cameras, such as a rear view camera, so that multiple overlap areas are generally present, and the entire measuring range of the spatial sensor may also be covered.

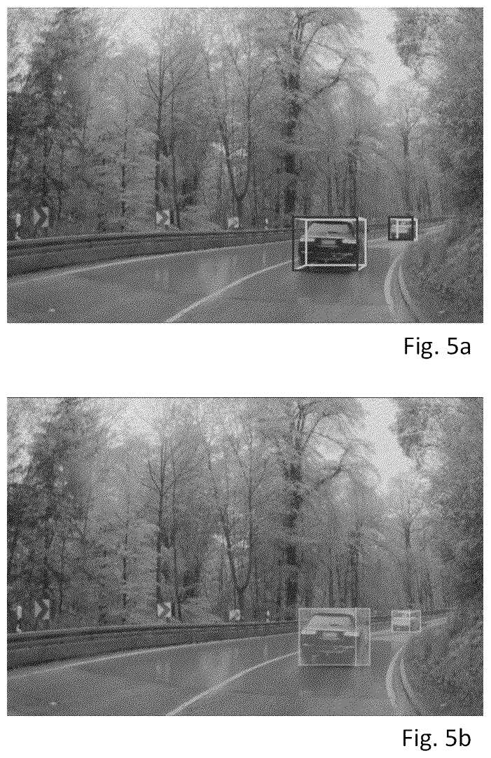

FIG. 5a shows an example of a camera image with a projected 3D bounding box. Three-dimensional bounding boxes of recognized objects may be projected into the camera image by projecting all eight corners of the three-dimensional bounding box onto the image plane. For example, the largest resulting rectangle may then be selected for checking the correlation with the area sensor (of the camera).

FIG. 5b shows an example of a camera image with a 2D bounding box. The bounding boxes determined by the annotation of a camera image are rectangles that are oriented along the axes (optionally with an additional vertical line, which, for example, indicates the pose, e.g. position and orientation, of a vehicle).

Returning to FIG. 3, the projected 3D bounding box may be compared to the bounding box that is determined from the area sensor, by calculating the relative overlap, i.e., the intersection over union (IoU). If the relative overlap exceeds a predefined threshold value, in particular 0.5, the bounding boxes match one another and may be assigned to the same object.

A component for “sample checking” is subsequently implemented, in which bounding boxes without sufficient overlap, or abandoned bounding boxes for which no corresponding bounding box has been found in the sensor data frame of the respective other sensor, are checked, and quality control for a sample of data points is additionally carried out. For this purpose, a first phase, “sampling,” bounding boxes for the quality control are selected based on sample requirements. In a second phase, “checking and correction,” the frame with possibly present bounding boxes may be shown to a human quality controller. The controller may be asked whether the bounding box is correct, and the controller may be shown a user interface for adjusting the bounding box and/or adding a bounding box in the case of “false negatives.”

If an insufficient relative overlap was present, there may be two cases: First, the object recognition may take place in the sensor data frame of the spatial sensor, whereas no object was recognized in the sensor data frame of the area sensor. It is then advantageous to initially display the frame of the spatial sensor and to ask whether a false positive recognition was present. If the answer is “yes,” the bounding box may be discarded. If “no,” an automatic projection of the 3D bounding box into the frame of the area sensor, in particular the camera image, may be shown to the controller. This simplifies the insertion of the two-dimensional bounding box. The inserted bounding box and the original three-dimensional bounding box may be linked to the same object. Second, the object recognition may take place in the sensor data frame of the area sensor, whereas no object was recognized in the sensor data frame of the spatial sensor. It is then advantageous to initially display the frame of the area sensor and to ask whether a false positive recognition was present. If the answer is “yes,” the bounding box may be discarded. If “no,” measuring points of the spatial sensor may be projected into the image plane of the area sensor, wherein all measuring points whose projection lies within the two-dimensional bounding box may be highlighted, using color or by increasing the intensity. When the three-dimensional sensor data frame is being considered, the human controller, or an annotation component, may then check the areas with highlighted measuring points in a targeted manner for the presence of an object. This reduces the complexity of searching for false negatives. Based on the type and the number of corrections made, the automation system advantageously determines a measure of quality. For example, a correction of the coordinates of a bounding box may be assessed based on the extent of the deviation. Missing bounding boxes may be assessed with a high constant error value or an error value that is proportional to the surface area.

In a subsequent step, sample checking “passed?”, the system determines whether the measure of quality of the sample was above a predefined threshold value (which indicates adequate annotation quality). If the automation system establishes that this is the case (“yes”), the determination of object attributes for the recognized objects may take place. If this is not the case (“no”), the evaluation of the charge of sensor data frames is postponed until a retrained automation component is available. For this purpose, it may be provided to use the corrected sensor data frames, and/or an additional correction of sensor data frames may take place in order to obtain a sufficient quantity of training data. The execution is continued with a check “necessary for the data set?” in order to determine whether the corrected data or additional data are to be used for retraining the automation component in question for object recognition.

If the quality check is passed, the automation engine implements at least one component for determining object attributes. In addition, a “context” may advantageously be determined from state parameters. The state parameters may be recording conditions, such as a recording location or light conditions, or may also be other data points such as the size of the bounding box or of the object. Since object attributes are often determined only from sensor data frames of a surroundings sensor, in particular the area sensor or the camera, parameters that are relevant in particular for this sensor may have an influence on the quality of the object attributes.

In a further step, “clustering,” the individual data points or object attributes of a certain type are grouped based on state parameters. It may be provided to assign certain state parameters to one type of data point. The state parameters for accuracy of the coordinates of bounding boxes may include, for example, the size of the bounding box, the time of day, and/or the weather conditions during recording of the image, and/or a partial occlusion of the object. The values of the state parameters of the individual object attributes may form multiple clusters in the multidimensional space that is spanned by the state parameters. Various clusters may be associated with a different quality of the annotations.

Based on a plurality of individual data points or object attributes of the same type, the automation system may thus determine clusters in a multidimensional space, in particular using a nearest neighbor algorithm and/or an unsupervised learning approach and/or a machine learning classification model. The determined clusters may be analyzed to establish a criterion for the grouping of data points and/or the prediction of the annotation quality, by defining value ranges for at least one of the state parameters of the data point.

The grouping is preferably carried out based on defined value ranges for multiple state parameters; it may also be carried out by a neural network or a machine learning classification model, based on value ranges.

In a component for “sample checking,” the quality control is carried out for a sample of object attributes or data points. In a first phase, “sampling,” multiple data points are selected for the quality control, based on sample requirements. The frequency and/or size of the samples withdrawn for a group of data points may be selected as a function of the predicted quality of the data points in the group; for data points that are associated with state attributes that indicate poor quality, samples may be taken more frequently. In a second phase, “checking and correction,” the frame with corresponding annotations and a user interface for inputting corrections may be shown to a human controller. The automation system determines a measure of quality based on the type and the number of corrections made by the human controller.

In a subsequent step, sample checking “passed?”, the system determines whether the measure of quality of the sample was above a predefined threshold value (which indicates adequate annotation quality). If the automation system determines that this is the case (“yes”), the group of sensor data frames including the selected sample may be exported and delivered to the customers. If this is not the case (“no”), the execution is continued in a further step for improving the automation components.

In the further step “necessary for the data set?”, it is determined whether the manually corrected sample is to be used for the new training of the automation component for the data point or the object attributes. Whether this is the case may depend on how many images, which have already been used for training the model, have been recorded under the same conditions. If this is not the case (“no”), the group of data points from which the sample has been withdrawn is sent back to the scheduler (to once again automate using the retrained model). As soon as a newly trained automation component for the data points is available, the scheduler sends the group of data points to the automation engine for reprocessing. If the corrected samples are to be used for the retraining (“yes”), the manually annotated data points are fed into the training, validation, or test data sets for the particular neural network/the automation component. These data sets are represented by a cylinder. In addition, further sensor data frames may be manually annotated in a “correction” step to obtain further training data. During the correction, manual annotation of a subset of the group of sensor data frames is advantageously carried out, and is used by feeding the corrected data into the training, validation, or test data sets for retraining the neural network.

In a further component, the “flywheel,” the neural network or the automation component that has generated the rejected data points during the sample check is retrained. The quality of the automation is improved by the learning by the neural network. The automation components are preferably improved to such an extent that manual checking is no longer necessary for the greatest possible number of clusters. The iteration times for the retraining should be as short as possible to allow a rapid improvement in the efficiency.

The flywheel involves techniques for efficiently storing and versioning of training data sets for each automation component or each type of data point, for supervising changes in the training data sets, and for automatically triggering a retraining as soon as predefined or automatically determined threshold values for changes in the training data sets are exceeded (for example, a predefined number of new examples). In addition, the flywheel involves techniques for automatically using retrained neural networks in automation components and informing the scheduler of version changes.

The method according to the invention allows the sensitivity or the recall to be increased during early labeling phases. In addition, a qualitative evaluation of the results of the automation system is made possible. Since the subordinate steps for determining secondary data points are carried out only after reliable object recognition, the annotation complexity is reduced, and time, computing power, and energy are saved.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for automatically annotating sensor data, the method comprising:
receiving a plurality of sensor data frames, including sensor data frames of a spatial sensor, in particular a lidar sensor, and sensor data frames of an area sensor or a camera, the measuring ranges of the spatial sensor and of the area sensor spatially overlapping;
annotating the plurality of sensor data frames using at least one neural network, the annotation including recognizing objects and assigning a bounding box to each object;
grouping a sensor data frame of the spatial sensor and a sensor data frame of the area sensor based on a temporal correlation of the measuring points in time;
projecting at least four corners of a three-dimensional bounding box of a recognized object or a bounding box in the sensor data frame of the spatial sensor, into the image plane of the area sensor to obtain a projected rectangle;
checking whether the relative overlap or the intersection over union, between the projected rectangle and a neighboring two-dimensional bounding box or a bounding box in the sensor data frame of the area sensor, exceeds a threshold value or a threshold value of at least 0.50;
linking, if the relative overlap exceeds the threshold value, the three-dimensional bounding box and the neighboring two-dimensional bounding box to the same object and carrying out attribute recognition for the object; and
correcting, if the relative overlap does not exceed the threshold value, the bounding boxes.

2. The method according to claim 1, wherein prior to grouping a sensor data frame of the spatial sensor and a sensor data frame of the area sensor, based on a temporal correlation of the measuring points in time, tracking of objects in sequential sensor data frames of the spatial sensor and/or tracking of objects in sequential sensor data frames of the area sensor takes place.

3. The method according to claim 1, wherein the projection of the corners of a bounding box in the sensor data frame of the spatial sensor into the image plane of the area sensor includes selection of a rectangle or the largest rectangle obtained from the projection, and a regression of the size takes place for the projected rectangle and/or the bounding box of the area sensor.

4. The method according to claim 1, wherein the correction of the bounding boxes includes receiving corrected annotations for the sensor data frames of the sample and retraining the neural network, using the sensor data frames of the sample.

5. The method according to claim 1, wherein the correction of the bounding boxes when a bounding box is present in the sensor data frame of the spatial sensor includes receiving a determination of whether an incorrect object recognition was present, and if an object was actually present, projection of the corners of the three-dimensional bounding box of the object into the image plane of the area sensor takes place in order to obtain a projected rectangle, and a regression of the size of the projected rectangle is subsequently carried out.

6. The method according to claim 1, wherein the correction of the bounding boxes when a bounding box is present in the sensor data frame of the area sensor includes receiving a determination of whether an incorrect object recognition was present, and if an object was actually present, projection of measuring points of the point cloud of the spatial sensor into the image plane of the area sensor takes place, and the measuring points whose projection is situated within the two-dimensional bounding box are highlighted in the point cloud.

7. The method according to claim 1, wherein the plurality of sensor data frames also include, in addition to sensor data frames of a spatial sensor or a lidar sensor, sensor data frames of at least two area sensors, or cameras, the measuring ranges of the spatial sensor and of the first area sensor spatially overlapping in a first overlap area, and the measuring ranges of the spatial sensor and of the second area sensor spatially overlapping in a second overlap area; for objects in the first overlap area an automatic annotation takes place independently of sensor data frames of the second area sensor, and for objects in the second overlap area an automatic annotation takes independently of sensor data frames of the first area sensor.

8. The method according to claim 1, wherein carrying out the attribute recognition for the object includes assigning at least one object attribute to the object and assigning at least one state parameter to the object attribute, the method further comprising:
grouping the object attributes based on the at least one state parameter, wherein a first group includes object attributes for which the at least one state parameter lies in a defined value range; and
selecting a sample of one or more object attributes from the first group and determining a measure of quality for the object attributes in the sample;
wherein, if the measure of quality of the sample is below a predefined threshold value, the method further comprises:
receiving corrected annotations for the data points in the sample; and
retraining the neural network based on the data points in the first sample.

9. The method according to claim 1, wherein the at least one state parameter includes a geographical location, a time of day, a weather condition, a visibility condition, a roadway type, a distance from an object, and/or a traffic density, a size of a bounding box, an extent of an occlusion and/or clipping, an ego vehicle speed, a camera parameter, a color range, and/or a measure of contrast of an area encompassed by a bounding box, a travel direction of the ego vehicle, astronomical information such as the position of the sun relative to the travel direction of the ego vehicle.

10. A nonvolatile computer-readable medium that comprises instructions which, when executed by a processor of a computer system, prompt the computer system to carry out the method according to claim 1.

11. A computer system that comprises a host computer, the host computer comprising a processor, a working memory, a display, an input device, and a nonvolatile memory, wherein the nonvolatile memory contains instructions which, when executed by the processor, prompt the computer system to carry out the method according to claim 1.
